(19) United States
(12) Patent Application Publication
(10) Pub. No.: US 2025/0036659 A1
(43) Pub. Date: Jan. 30, 2025

(54) DATA INSIGHTS USING CONTEXT DRIVEN LATERAL AI

(71) Applicant: Kyndryl, Inc., New York, NY (US)

(72) Inventors: KALPESH SHARMA, BANGALORE (IN); Muniyandi Perumal Thevar, Madurai (IN); Nalini M, CHENNAI (IN); Veeresh Bushetti, Savanur (IN)

(21) Appl. No.: 18/361,563

(22) Filed: Jul. 28, 2023

(51) Int. Cl. G06F 16/28; G06F 16/22

(52) U.S. Cl. CPC G06F 16/287; G06F 16/2255

(57) ABSTRACT

An approach is disclosed that receives a user activity from a user that is using a datastore visualization display. The display displays a first visualization pertaining to one or more datastores with the datastore visualization display provided at least in part by a context driven lateral artificial intelligence (CDLAI) engine. The received user activity is provided as input to the CDLAI to generate a second visualization that is displayed to the user at the datastore visualization display that is displayed to the user. Artificial intelligence (AI) models that are used by the CDLAI are then trained based on the received user activity. The training results in updates to the visualizations.

### BACKGROUND

Traditional data insights and visualizations are generally static, and therefore rather narrow in application. While data is often a key component to a specific domain, using pre-programmed insights requires large human resources to determine the insights that are to be provided, program the static insights that users can visualize regarding enterprise data sets, and maintenance efforts to maintain a plethora of static, pre-programmed organizational insights.

### SUMMARY

An approach is disclosed that receives a user activity from a user that is using a datastore visualization display. The display displays a first visualization pertaining to one or more datastores with the datastore visualization display provided at least in part by a context driven lateral artificial intelligence (CDLAI) engine. The received user activity is provided as input to the CDLAI to generate a second visualization that is displayed to the user at the datastore visualization display that is displayed to the user. Artificial intelligence (AI) models that are used by the CDLAI are then trained based on the received user activity. The training results in updates to the visualizations.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting a high-level overview of an approach that provides data insights using a context driven lateral artificial intelligence (AI) system;

FIG. 4 is a flowchart depicting a detailed overview of an approach that provides data insights using a context driven lateral artificial intelligence (AI) system;

FIG. 5 is a diagram depicting interaction between a navigation system utilized by a user and a context driven lateral AI system that continually learns from chart contexts and associated data set; and

FIG. 6 is a diagram depicting an example graph between analytics functions and datapoints.

### DETAILED DESCRIPTION

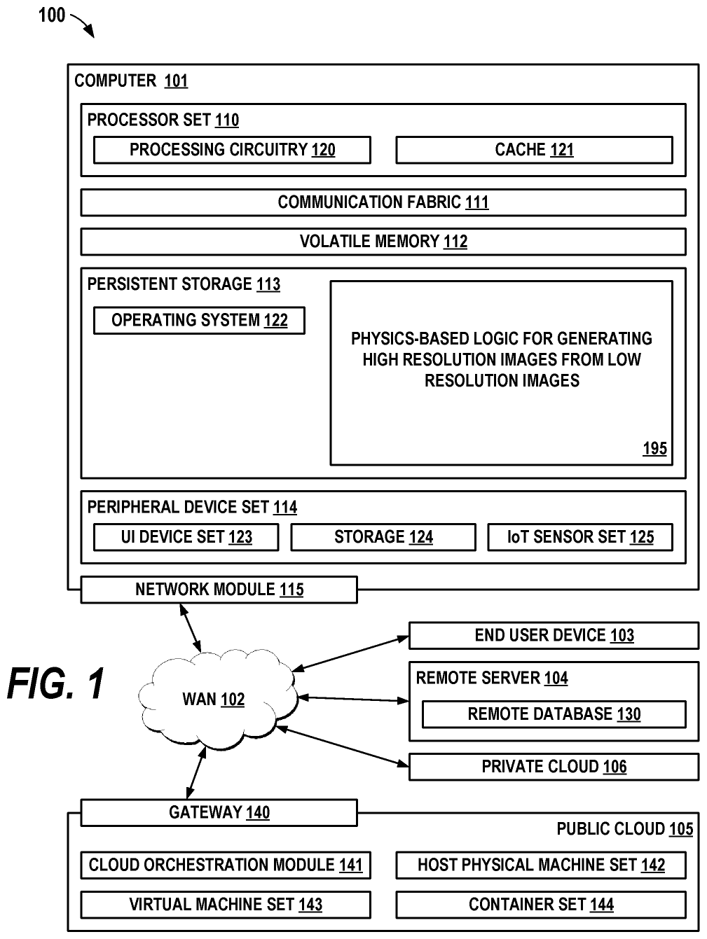

FIGS. 1-6 describe an approach that differentiates non-clickable clicks from routine and identifies deep, context-driven navigation paths and related insights using insights and their associated datasets. In this proposed approach, the user visualizes insights in the given context and is enhanced by a context driven lateral artificial intelligence (AI) engine (“CDLAI”). The CDLAI continuously processes and identifies new contexts using related data using the current insights data.

For example, consider the sales dataset scenario, where a user may see a sales trend bar chart by sales count and time period. Suppose, if the user wants to see the sales amount by duration, then the user needs to select another link or navigation button where new visualization is displayed. However, in the approach described herein, sales related insight, such as sales count by time period, will also recommend other possible insights like sales amount by time period by CDLAI in the same visualization dashboard. After selecting sales amount by time period insight, the system may recommend further new insights like sales target by time period, and this continues. Over the period, the system learns from the history using machine learning and returns accurate and recommended insights.

Some additional use case scenarios are as follows. In a first use case, consider a database containing a large amount of data for a particular bank. If a user wishes to analyze the number of transactions by different contexts, such as by transactions by year, transactions by quarter, transactions by month, transactions by success/failures, transactions by type of accounts, etc. the approach described herein provides such flexibility.

In a second use case, consider a data lake containing a large amount of data for a particular account with this data being changed and updated frequently. However, users, such as an account admin or an executive, want to view the data from various other perspectives periodically, such as incidents by quarter, incidents by developer, incidents by status, etc. The approach described herein can handle the flexibility needed, whereas in a traditional setting, handling this use case is difficult because of the growing data and because the users' needs are different and should be dynamic based on data, such as provided by the approach described herein.

In the above scenarios, the approach described herein provides a system and method that identifies the relationships between the datasets and generates visualizations, such as charts, dynamically, while further considering user activity and preferences. In this manner, the approach described herein provides a lateral detailed view regarding the data to the end user in near real-time.

The approach provides a method to leverage non-clickable chart zones to trigger contextual recommendations for taking the user to various possible insights based on the associated datasets. The approach further provides a Context Driven Lateral AI Engine (CDLAI) that identifies associated datasets to provide the various options based on the possible associated insights. In addition, the approach encourages inter-user activities through a machine learning (ML) model library that reflects the live changes to visual indexes corresponding to the visualizations.

The terminology used herein is for the purpose of describing embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

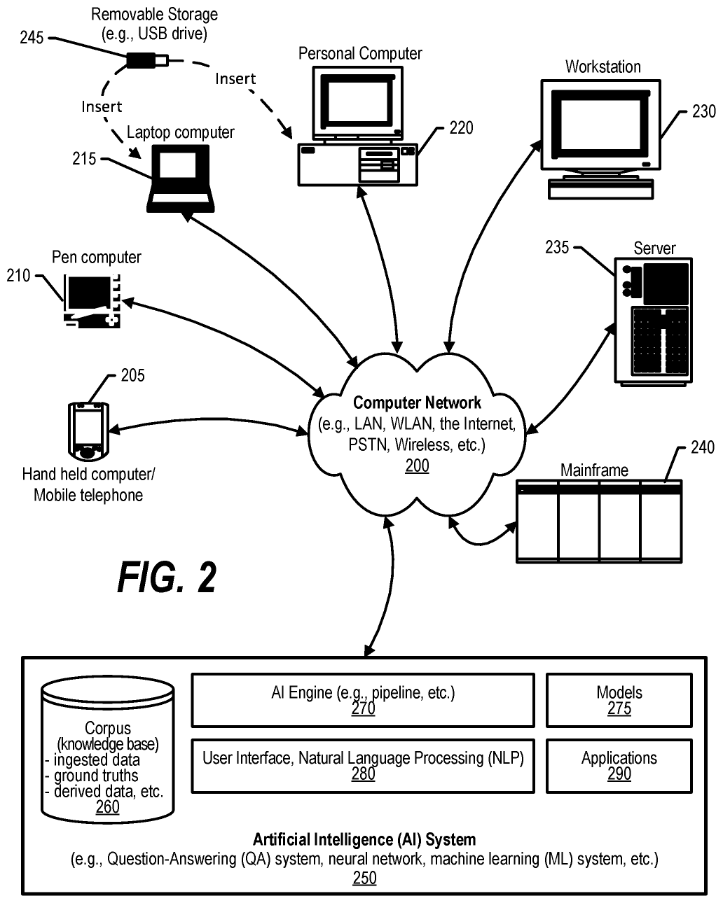

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 1 is a block diagram of a data processing system in which the methods described herein can be implemented. Computing environment 100 contains an example of an environment for the execution of at least some of the computer code involved in performing the inventive methods, such as shown in the description of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A NETWORKED ENVIRONMENT is shown in FIG. 2. The networked environment provides an extension of the information handling system shown in FIG. 1 illustrating that the methods described herein can be performed on a wide variety of information handling systems that operate in a networked environment, depicted by computer network 200. Types of computer networks can include local area networks (LANs), wide area networks (WANs), the Internet, peer-to-peer networks, public switched telephone networks (PSTNs), wireless networks, etc. Types of information handling systems range from small handheld devices, such as handheld computer/mobile telephone 205 to large mainframe systems, such as mainframe computer 240. Examples of handheld computer 205 include smart phones, personal digital assistants (PDAs), personal entertainment devices, such as MP3 players, portable televisions, and compact disc players. Other examples of information handling systems include pen, or tablet, computer 210, laptop, or notebook, computer 215, personal computer 220, workstation 230, and server computer system 235. Other types of information handling systems that are not individually shown in FIG. 2 can also be interconnected other computer systems via computer network 200.

Many of the information handling systems include nonvolatile data stores, such as hard drives and/or nonvolatile memory depicted in FIG. 1. These nonvolatile data stores and/or memory can be included, or integrated, with a particular computer system or can be an external storage device, such as an external hard drive. In addition, removable nonvolatile storage device 245 can be shared among two or more information handling systems using various techniques, such as connecting the removable nonvolatile storage device 245 to a USB port or other connector of the information handling systems.

An ARTIFICIAL INTELLIGENCE (AI) SYSTEM is depicted at the bottom of FIG. 2. Artificial intelligence (AI) system 250 is shown connected to computer network 200 so that it is accessible by other computer systems 205 through 240. AI system 250 runs on one or more information handling systems (comprising one or more processors and one or more memories, and potentially any other computing device elements generally known in the art including buses, storage devices, communication interfaces, and the like) that connects AI system 250 to computer network 200. The network 200 may include multiple computing devices 104 in communication with each other and with other devices or components via one or more wired and/or wireless data communication links, where each communication link may comprise one or more of wires, routers, switches, transmitters, receivers, or the like. AI system 250 and network 200 may enable functionality, such as question/answer (QA) generation functionality, for one or more content users. Other embodiments of AI system 250 may be used with components, systems, sub-systems, and/or devices other than those that are depicted herein.

AI system 250 maintains corpus 260, also known as a “knowledge base,” which is a store of information or data that the AI system draws on to solve problems. This knowledge base includes underlying sets of facts, ground truths, assumptions, models, derived data, and rules which the AI system has available to solve problems. In one embodiment, a content creator creates content in corpus 260. This content may include any file, text, article, or source of data for use in AI system 250. Content users may access AI system 250 via a network connection or an Internet connection to the network 200, and, in one embodiment, may input questions to AI system 250 that may be answered by the content in the corpus of data. As further described below, when a process evaluates a given section of a document for semantic content, the process can use a variety of conventions to query it from the AI system.

AI system 250 may be configured to receive inputs from various sources. For example, AI system 250 may receive input from the network 200, a corpus of electronic documents or other data, a content creator, content users, and other possible sources of input. In one embodiment, some or all of the inputs to AI system 250 may be routed through the network 200. The various computing devices on the network 200 may include access points for content creators and content users. Some of the computing devices may include devices for a database storing the corpus of data. The network 200 may include local network connections and remote connections in various embodiments, such that AI system 250 may operate in environments of any size, including local and global, e.g., the Internet. Additionally, AI system 250 serves as a front-end system that can make available a variety of knowledge extracted from or represented in documents, network-accessible sources and/or structured data sources. In this manner, some processes populate the AI system with the AI system also including input interfaces to receive knowledge requests and respond accordingly.

AI Engine 270, such as a pipeline, is an interconnected and streamlined collection of operations. The information works its way into and through a machine learning system, from data collection to training models. During data collection, such as data ingestion, data is transported from multiple sources, such as sources found on the Internet, into a centralized database stored in corpus 260. The AI system can then access, analyze, and use the data stored in its corpus.

Models 275 are the result of AI modeling. AI modeling is the creation, training, and deployment of machine learning algorithms that emulate logical decision-making based on the data available in the corpus with the system sometimes utilizing additional data found outside the corpus. AI models 275 provide AI system 250 with the foundation to support advanced intelligence methodologies, such as real-time analytics, predictive analytics, and augmented analytics.

User interface 280, such as Natural Language (NL) Processing (NLP) is the interface provided between AI system 200 and human uses. Semantic content is content based on the relation between signifiers, such as words, phrases, signs, and symbols, and what they stand for, their denotation, or connotation. In other words, semantic content is content that interprets an expression, such as by using NLP. Semantic data is stored as part of corpus 260. In one embodiment, the process sends well-formed questions (e.g., natural language questions, etc.) to the AI system. AI system 250 may interpret the question and provide a response to the content user containing one or more answers to the question. In some embodiments, AI system 250 may provide a response to users in a ranked list of answers. Other types of user interfaces (UIs) can also be used with AI system 250, such as a command line interface, a menu-driven interface, a Graphical User Interface (GUI), a Touchscreen Graphical User Interface (Touchscreen GUI), and the like.

AI applications 290 are various types of AI-centric applications focused on one or more tasks, operations, or environments. Examples of different types of AI applications include search engines, recommendation systems, virtual assistants, language translators, facial recognition and image labeling systems, and question-answering (QA) systems.

In some illustrative embodiments, AI system 250 may be a question/answering (QA) system, which is augmented with the mechanisms of the illustrative embodiments described hereafter. A QA type of AI system 250 may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analyses, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the I QA system. The statistical model may then be used to summarize a level of confidence that the QA system has regarding the evidence that the potential response, i.e., candidate answer, is inferred by the question. This process may be repeated for each of the candidate answers until the QA system identifies candidate answers that surface as being significantly stronger than others and thus, generates a final answer, or ranked set of answers, for the input question.

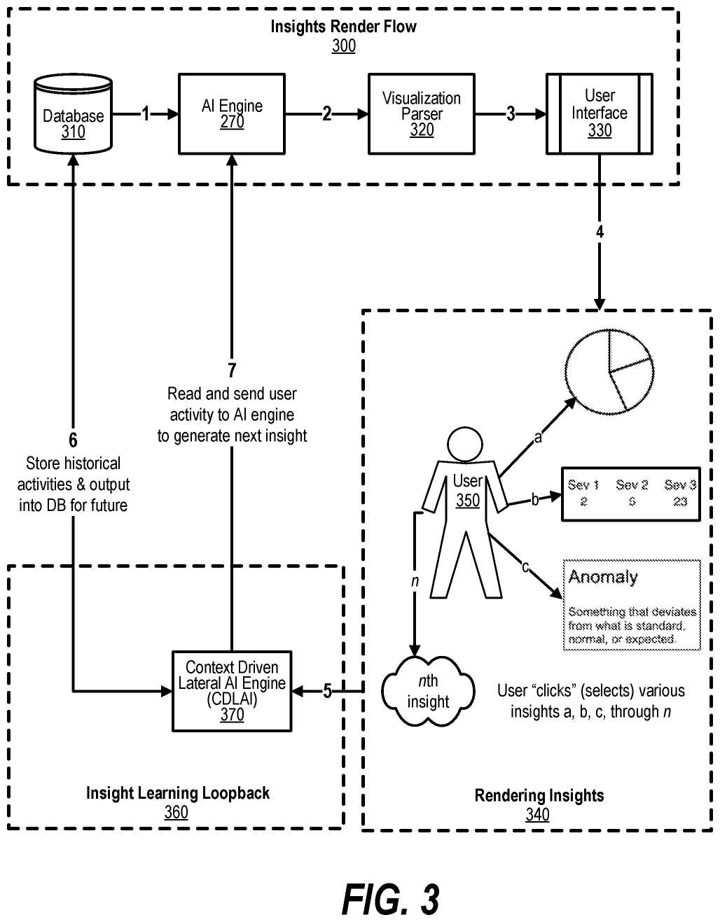

FIG. 3 is a diagram depicting a high-level overview of an approach that provides data insights using a context driven lateral artificial intelligence (AI) system. At 300, the Insights Render Flow process is performed utilizing database 310 where historical data and outputs are stored for use by AI engine 270 which provides visualization parser 320 that is utilized by user interface process (predefined process 330).

At 340, the Rendering Insights process is performed where user 350 utilizes the user interface (predefined process 330) to view insights from various visualizations of a datastore visualization display. In the example shown, user 350 requests insights (visualizations) a, b, c, and n. A pie chart is displayed, and the user performs an activity, such as clicking (selecting) on an area (clickable or non-clickable area) of the pie chart that results in the second chart (b) being displayed. One possible insight is an “anomaly” visualization that, in the example, is displayed after the second visualization. Any number of insights, signified by “n” insights, can be displayed in response to user activities performed when a visualization is displayed (e.g., user clicks on clickable or non-clickable area of displayed visualization, etc.).

The user activities and resulting outputs are processed by Insight Learning Loopback process 360. Here, the Context Driven Lateral AI Engine (CDLAI 370) stores the historical user activities and resulting outputs in database 310 for future use (learning) by AI Engine 270. In addition, CDLAI 370 reads and sends the user activity to AI Engine 270 so that the AI Engine can generate the next insight (visualization) that is then processed by visualization parser 320 so that the new visualization can be displayed to user 350 via the user interface (predefined process 330). As shown, this process loops however many times that the user requests additional insights regarding one or more datastores with CDLAI 370 continually storing the historical data into database 310 and continually feeding AI Engine 270 with user activity data and outputs so that the AI Engine (e.g., model used by the AI engine, etc.) continually learns new visualizations based on the user activities and previous resulting visual insights (visualizations).

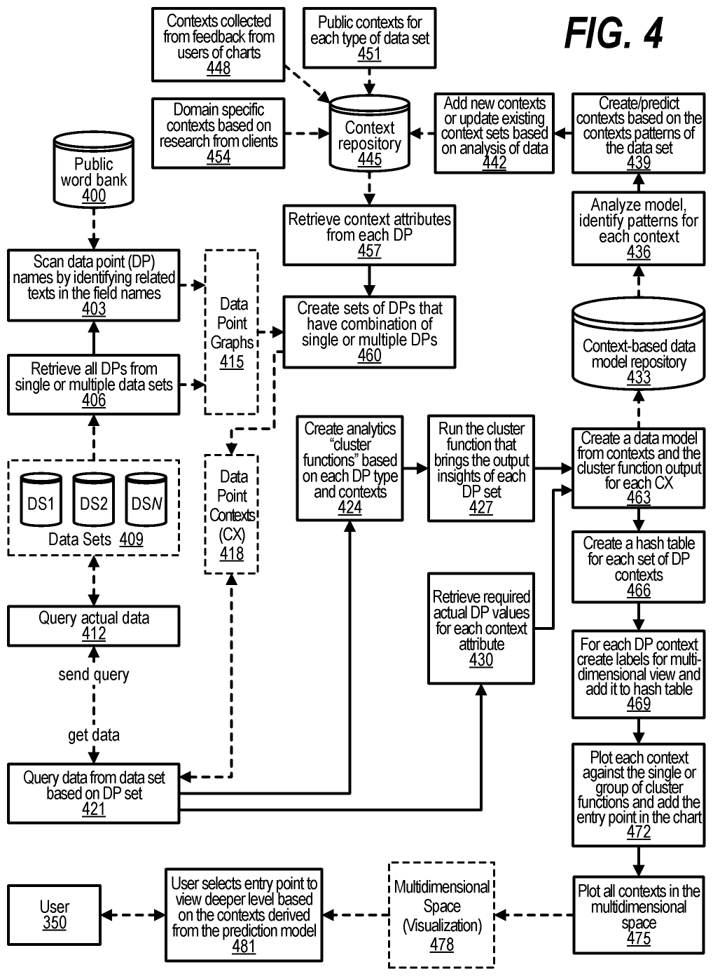

FIG. 4 is a flowchart depicting a detailed overview of an approach that provides data insights using a context driven lateral artificial intelligence (AI) system. At step 403, the process scans data point (DP) names by identifying related texts in the field names. The process retrieves related texts from public word bank stored in data store 400. The DP names having been retrieved by the process at step 406 where the data points are retrieved from one or more data sets 409. Data sets 409 are provided from queries of actual data stores (e.g., databases, etc.) with step 412 being used to query the actual data and step 421 being used to query data from the data sets based on the data point (DP) set. The scanned data point (DP) names identified from related texts (step 403) and the retrieval of all of the data points from the data sets (step 406) are used to create Data Point Graphs 415.

An initial Data Point Graph 415 might be a predefined data point graph, such as a standard graph (e.g., pie chart, etc.) of one or more data sets 409. From Data Point Graph 415, step 460 creates sets of data points that have a combination of a single or multiple data points. These sets are created from data point graphs and by using context attributes that are retrieved from each data point at step 457. These sets of data points that have single or multiple data points result in Data Point Contexts (CX) that are stored in memory area 418.

The context attributes that are retrieved for each data point at step 457 retrieve the context attributes from context repository data store 445. The context repository data store stores context attributes from a variety of sources. These sources include contexts that are collected from feedback from the users of the charts (448), public contexts for each type of data set (451), and domain specific contexts such as contexts that are based on research received from clients (454). In addition, the process described in FIG. 4 continually adds new contexts and/or updates existing context sets based on an analysis of data that is performed when the process shown in FIG. 4 is executed.

Contexts that are added and the updated contexts of existing context sets performed at step 442 receives the new contexts and updates from the processing of the querying of data from a number of steps that commence with the data set based on the DP set that is performed at step 421. The querying of data at step 421 results in creating analytics “cluster functions” that are based on each DP type and their contexts that are performed at step 424. The created cluster functions that bring the output insights (visualizations) of each DP set are executed at step 427. In addition, at step 430, the process retrieves the required actual data point values for each context attribute.

At step 463, the process takes input from steps 427 and 430 to create a data model from the contexts and the cluster function output for each data point context (CX). The data model is stored in context-based data model repository 433. At step 436, context-based data model repository 433 is analyzed to identify patterns for each context found in the data model. Based on the analysis, at step 439, the process creates and predicts contexts based on the context patterns found in the data set. At step 442, the process takes these created and predicted contexts from step 439 to add new contexts and update existing contexts which are stored in context repository 445.

Returning to step 463, the data model that is created is also used to provide a visualization that is utilized by user 350 to perform a user activity (e.g., selection of a non-clickable area displayed in the visualization, etc.). At step 466, the process creates a hash table for each set of data point contexts. At step 469, the process creates labels for a multidimensional view (visualization) that will be displayed to user 350. The labels are created for each data point context that were stored in 418 by process 460 after step 430 retrieved the required actual data point values for each context attribute.

At step 472, the process plots each context against the single or group of cluster functions (created at step 424 and executed at step 427) and adds the entry point to the chart in the multidimensional view (visualization). At step 475, all of the contexts are plotted in the chart in the multidimensional view (visualization). This results in a new multidimensional space (visualization) 478 that is displayed to the user at a datastore visualization display. At step 481, user 350 an entry point that appears in the datastore visualization display (e.g., a clickable or non-clickable area in the display, etc.) that results in another the processing described above processing the entry point to create another (e.g., second, third, etc.) visualization that is again displayed to the user in the datastore visualization display. At step 481, the user selects an entry point to view a deeper level (next visualization) that is based on the contexts derived from the prediction model (new context-based data model repository being created as described above followed by analysis in step 436, created/predicted contexts in step 439, and new or updated contexts in step 442 being used to update the content repository stored in data store 445).

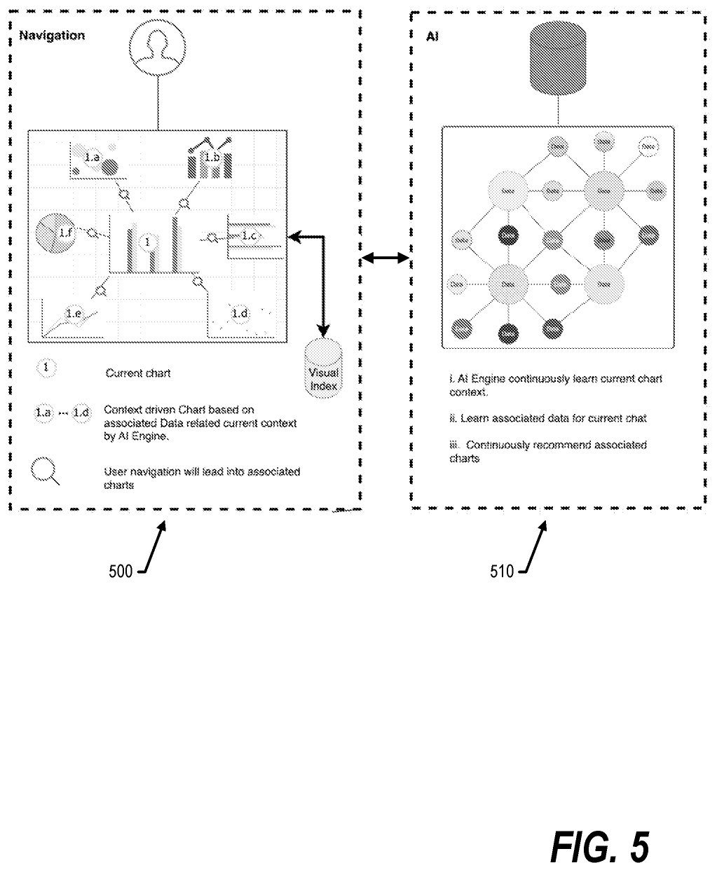

FIG. 5 is a diagram depicting interaction between a navigation system utilized by a user and a context driven lateral AI system that continually learns from chart contexts and associated data set. The processing steps shown in FIG. 4 result in both user navigation process 500 as well as artificial intelligence (AI) process 510.

In navigation process 500, the user starts with a current chart (first visualization), depicted as 1. User actions (e.g. click on part of the chart, etc.) result in one or more context-driven charts (second, third, etc. visualizations) depicted as 1.a, 1.b, 1.c, 1.d., etc. The user's actions, depicted with a magnifying glass, are processed by the system to lead to associated charts that are dynamically created by AI system process 510, as described in detail in FIG. 4 and related textual descriptions. In one embodiment, within a functional/data area (e.g., “clickable” areas, etc.) the process exhibits usual behavior of providing a drill down views upon a user action (click). In this same embodiment, outside such functional areas (e.g., non-clickable areas, etc.) the process helps differentiate and offer options such as a roundabout (instead of a drilldown) where a user has options to take various exits. Similar to that any clicks within non-clickable zone result in the process offering insights (visualizations) that are related to datapoints or datasets which are laterally related and not a drilldown.

AI system process 510 continually learns chart context data corresponding to the current chart that is being displayed to the user (e.g., charts 1, 1.a, 1.b . . . 1.f from user navigation process 500). In addition, the AI system, as discussed in FIG. 4, learns the associated data for the current chart that is displayed in the datastore visualization display (first visualization, second visualization, etc.). By learning the current chart context and by learning the associated data for the current chart, the AI system is able to continuously recommend associated (e.g., “deeper,” etc.) charts to the user that the user can display with an action (e.g., click on an entry point of the current chart, etc.).

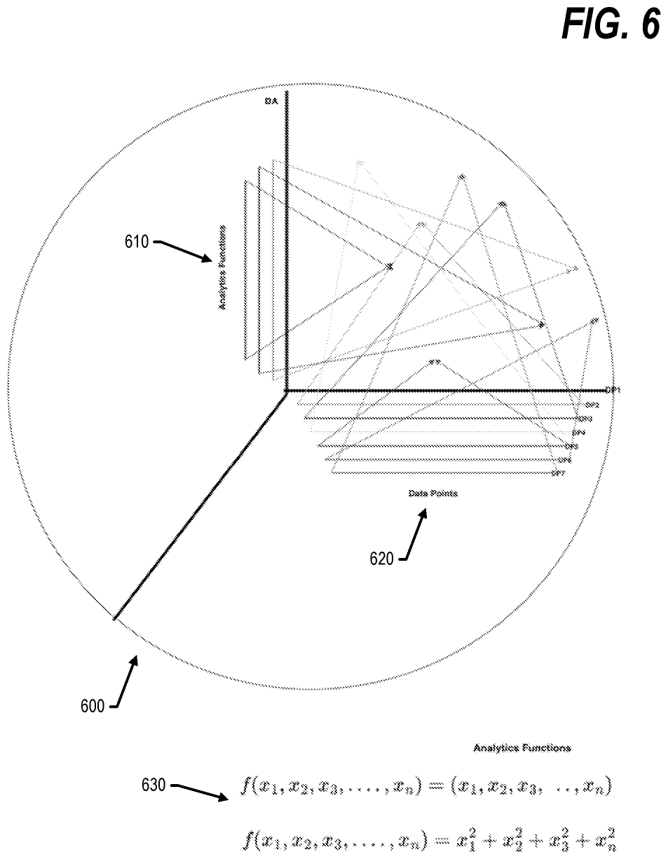

FIG. 6 is a diagram depicting an example graph between analytics functions and datapoints. As discussed above in FIGS. 4 and 5, the system finds the points which are non-clickable and allows the user to navigate deep and roundabout with respect to entry points. FIG. 6 depicts graph 600 that depicts an x-axis of data points (620) and a y-axis depicting analytic functions (610). An example of analytics functions is shown in 630.

For example, the graph may be plotted against product price with respect to geo-graphical location where the x-axis is the location and the y-axis is the product price. Each point in the graph represents one location, if the user clicks on a location, the process generates and displays another visualization that reveals n-number of perspectives about the price (e.g. production cost, transport cost, local produce, labor, quality etc.) in a round-about all these features will be listed. In this manner, the user can choose any of these perspectives to receive even more insights, for example labor (the process can display a visualization of a labor cost map for each area inside that location, etc.), again the user can click on areas of the visualization to receive additional round-abouts of labor perspective (experience, total hours etc.).

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method, implemented by a processor coupled to a memory, comprising:
receiving, from a user, a user activity at a datastore visualization display that displays a first visualization pertaining to one or more datastores, wherein the datastore visualization display is provided at least in part by a context driven artificial intelligence engine;
inputting the received user activity to the context driven artificial intelligence engine to generate a second visualization that is displayed to the user at the datastore visualization display; and
training one or more artificial intelligence (AI) models that are used by the context driven artificial intelligence engine based on the received user activity, wherein the training results in one or more updates to one or more visualizations that include the first and second visualizations.

2. The method of claim 1 further comprising:
gathering a set of data points from the datastores;
scanning a word bank for a plurality of data point names by identifying related texts in a plurality of field names included in the datastores;
retrieving one or more context attributes corresponding to one or more of the data points; and
based on the one or more data points, the related texts, and the corresponding context attributes, creating a plurality of data point contexts.

3. The method of claim 2 further comprising:
querying a set of data from the datastores using the created data point contexts, the querying resulting in a plurality of analytics cluster functions based on the data point contexts, one or more data point types and a plurality of actual data point values corresponding to each context attribute; and
creating a new AI data model for use by the context driven artificial intelligence engine, the new AI data model being created from the running of the created the plurality of analytics cluster functions that utilizes the plurality of actual data point values that correspond to each context attribute.

4. The method of claim 3 further comprising:
analyzing the new AI data model to identify one or more patterns corresponding to the data point contexts.

5. The method of claim 4 further comprising:
creating a new visualization based on the identified patterns corresponding to the data point contexts; and
training one or more of the AI models based on the created new visualization.

6. The method of claim 5 further comprising:
storing the new visualization and the updates to the visualizations in a context repository;
storing a plurality of domain specific contexts in the context repository; and
storing a plurality of user feedback contexts in the repository.

7. The method of claim 6 wherein the user activity is a selection of an area that is a non-clickable area of the visualization display and the method further comprises:
creating a hash table of the data point contexts;
creating one or more labels corresponding to each of the data point contexts included in the hash table and including the created labels in the hash table;
plotting each data point context included in the hash table against at least one of the created analytics cluster functions, the plotting resulting in a set of entry points that are included in a multidimensional space;
displaying the multidimensional space to the user;
receiving, from the user, a selection of one of the entry points included in the displayed multidimensional space; and
responsively displaying a selected one of the visualizations from the context repository based on the entry point selected by the user.

8. An information handling system comprising:
one or more processors;
a memory coupled to at least one of the processors; and
a set of instructions stored in the memory and executed by at least one of the processors to perform actions comprising:
receiving, from a user, a user activity at a datastore visualization display that displays a first visualization pertaining to one or more datastores, wherein the datastore visualization display is provided at least in part by a context driven artificial intelligence engine;
inputting the received user activity to the context driven artificial intelligence engine to generate a second visualization that is displayed to the user at the datastore visualization display; and
training one or more artificial intelligence (AI) models that are used by the context driven artificial intelligence engine based on the received user activity, wherein the training results in one or more updates to one or more visualizations that include the first and second visualizations.

9. The information handling system of claim 8 wherein the actions further comprise:
gathering a set of data points from the datastores;
scanning a word bank for a plurality of data point names by identifying related texts in a plurality of field names included in the datastores;
retrieving one or more context attributes corresponding to one or more of the data points; and
based on the one or more data points, the related texts, and the corresponding context attributes, creating a plurality of data point contexts.

10. The information handling system of claim 9 wherein the actions further comprise:
querying a set of data from the datastores using the created data point contexts, the querying resulting in a plurality of analytics cluster functions based on the data point contexts, one or more data point types and a plurality of actual data point values corresponding to each context attribute; and
creating a new AI data model for use by the context driven artificial intelligence engine, the new AI data model being created from the running of the created the plurality of analytics cluster functions that utilizes the plurality of actual data point values that correspond to each context attribute.

11. The information handling system of claim 10 wherein the actions further comprise:
analyzing the new AI data model to identify one or more patterns corresponding to the data point contexts.

12. The information handling system of claim 11 wherein the actions further comprise:
creating a new visualization based on the identified patterns corresponding to the data point contexts; and
training one or more of the AI models based on the created new visualization.

13. The information handling system of claim 12 wherein the actions further comprise:
storing the new visualization and the updates to the visualizations in a context repository;
storing a plurality of domain specific contexts in the context repository; and
storing a plurality of user feedback contexts in the repository.

14. The information handling system of claim 13 wherein the user activity is a selection of an area that is a non-clickable area of the visualization display and the actions further comprise:
creating a hash table of the data point contexts;
creating one or more labels corresponding to each of the data point contexts included in the hash table and including the created labels in the hash table;
plotting each data point context included in the hash table against at least one of the created analytics cluster functions, the plotting resulting in a set of entry points that are included in a multidimensional space;
displaying the multidimensional space to the user;
receiving, from the user, a selection of one of the entry points included in the displayed multidimensional space; and
responsively displaying a selected one of the visualizations from the context repository based on the entry point selected by the user.

15. A computer program product comprising:
a computer readable storage medium comprising a set of computer instructions that, when executed by a processor, are effective to perform actions comprising:
receiving, from a user, a user activity at a datastore visualization display that displays a first visualization pertaining to one or more datastores, wherein the datastore visualization display is provided at least in part by a context driven artificial intelligence engine;
inputting the received user activity to the context driven artificial intelligence engine to generate a second visualization that is displayed to the user at the datastore visualization display; and
training one or more artificial intelligence (AI) models that are used by the context driven artificial intelligence engine based on the received user activity, wherein the training results in one or more updates to one or more visualizations that include the first and second visualizations.

16. The computer program product of claim 15 wherein the actions further comprise:
gathering a set of data points from the datastores;
scanning a word bank for a plurality of data point names by identifying related texts in a plurality of field names included in the datastores;
retrieving one or more context attributes corresponding to one or more of the data points; and
based on the one or more data points, the related texts, and the corresponding context attributes, creating a plurality of data point contexts.

17. The computer program product of claim 16 wherein the actions further comprise:
querying a set of data from the datastores using the created data point contexts, the querying resulting in a plurality of analytics cluster functions based on the data point contexts, one or more data point types and a plurality of actual data point values corresponding to each context attribute; and
creating a new AI data model for use by the context driven artificial intelligence engine, the new AI data model being created from the running of the created the plurality of analytics cluster functions that utilizes the plurality of actual data point values that correspond to each context attribute.

18. The computer program product of claim 17 wherein the actions further comprise:
analyzing the new AI data model to identify one or more patterns corresponding to the data point contexts.

19. The computer program product of claim 18 wherein the actions further comprise:
creating a new visualization based on the identified patterns corresponding to the data point contexts; and
training one or more of the AI models based on the created new visualization.

20. The computer program product of claim 19 wherein the user activity is a selection of an area that is a non-clickable area of the visualization display and the steps further comprise:
storing the new visualization and the updates to the visualizations in a context repository;
creating a hash table of the data point contexts;
creating one or more labels corresponding to each of the data point contexts included in the hash table and including the created labels in the hash table;
plotting each data point context included in the hash table against at least one of the created analytics cluster functions, the plotting resulting in a set of entry points that are included in a multidimensional space;
displaying the multidimensional space to a user;
receiving, from the user, a selection of one of the entry points included in the displayed multidimensional space; and
responsively displaying one of the visualizations from the context repository based on the entry point selected by the user.
